(19) United States
(12) Patent Application Publication
(10) Pub. No.: US 2024/0209532 A1
(43) Pub. Date: Jun. 27, 2024

(54) MULTILAYER ION-EXCHANGE MEMBRANE FOR ELECTROLYSIS APPLICATIONS

(71) Applicant: UOP LLC, Des Plaines, IL (US)

(72) Inventors: Chunqing Liu, Arlington Heights, IL (US); Shurong Yang, Naperville, IL (US); Xueliang Dong, Schaumburg, IL (US); Dennis F. van der Vliet, Skokie, IL (US); Zhihao Shang, Mount Prospect, IL (US); Matthew J. Schmidt, Roselle, IL (US)

(21) Appl. No.: 18/459,615

(22) Filed: Sep. 1, 2023

Related U.S. Application Data
(60) Provisional application No. 63/476,983, filed on Dec. 23, 2022.

(51) Int. Cl. C25B 13/08; C25B 9/23; C25B 11/052; C25B 11/081

(52) U.S. Cl. CPC C25B 13/08; C25B 9/23; C25B 11/052; C25B 11/081

(57) ABSTRACT

A new multilayer ion-exchange membrane comprising an ion-exchange membrane layer, a catalyst layer coated on a first surface of the ion exchange membrane, a first polyelectrolyte multilayer coated on the catalyst layer, and optionally a second polyelectrolyte multilayer coated on a second surface of the ion-exchange membrane for electrolysis applications has been developed.

### RELATED APPLICATIONS

This application claims priority to U.S. Provisional Patent Application Ser. No. 63/476,983 filed on Dec. 23, 2022, the entirety of which is incorporated herein by reference.

### FIELD OF THE INVENTION

The present invention relates to the ion-exchange membranes, and more particularly to such a membrane used in an electrochemical reaction.

### BACKGROUND

Hydrogen as an energy vector for grid balancing or power-to-gas and power-to-liquid processes plays an important role in the path toward a low-carbon energy structure that is environmentally friendly. Water electrolysis produces high quality hydrogen by electrochemical splitting water into hydrogen and oxygen; the reaction is given by Eq. 1 below. The water electrolysis process is an endothermic process and electricity is the energy source. Water electrolysis has zero carbon footprint when the process is powered by renewable energy sources, such as wind, solar, or geothermal energy. The main water electrolysis technologies include alkaline electrolysis, proton exchange membrane (PEM) water electrolysis (PEMWE as shown in FIG. 1), anion exchange membrane (AEM) water electrolysis (AEMWE as shown in FIG. 2), and solid oxide water electrolysis.

As shown in FIG. 1, in a PEMWE system 100, an anode 105 and a cathode 110 are separated by a solid PEM electrolyte 115, such as a sulfonated tetrafluoroethylene based cofluoropolymer sold under the trademark Nafion® by Chemours company. The anode and cathode catalysts typically comprise IrO₂ and Pt, respectively. At the positively charged anode 105, pure water 120 is oxidized to produce oxygen gas 125, electrons (e), and protons; the reaction is given by Eq. 2. The protons are transported from the anode 105 to the cathode 110 through the PEM 115 that conducts protons. At the negatively charged cathode 110, a reduction reaction takes place with electrons from the cathode 110 being given to protons to form hydrogen gas 130; the reaction is given by Eq. 3. The PEM 115 not only conducts protons from the anode 105 to the cathode 110, but also separates the H₂ gas 130 and O₂ gas 125 produced in the water electrolysis reaction. PEM water electrolysis is one of the favorable methods for conversion of renewable energy to high purity hydrogen with the advantage of compact system design at high differential pressures, high current density, high efficiency, fast response, small footprint, lower temperature (20-90° C.) operation, and high purity oxygen byproduct. However, one of the major challenges for PEM water electrolysis is the high capital cost of the cell stack comprising expensive acid-tolerant stack hardware such as the Pt-coated Ti bipolar plates, expensive noble metal catalysts required for the electrodes, as well as the expensive PEM.

$$Water electrolysis reaction : 2 {H}_{2} O \to 2 {H}_{2} + {O}_{2} \qquad ( 1 )$$

$$Oxidation reaction at anode for PEMWE : 2 {H}_{2} O \to {O}_{2} + 4 {H}^{+} + 4 {e}^{-} \qquad ( 2 )$$

$$Reduction reaction at cathode for PEMWE : 2 {H}^{+} + 2 e - \to {H}_{2} \qquad ( 3 )$$

AEMWE is a developing technology. As shown in FIG. 2, in the AEMWE system 200, an anode 205 and a cathode 210 are separated by a solid AEM electrolyte 215. Typically, a water feed 220 with an added electrolyte such as dilute KOH or K₂CO₃ or a deionized water is fed to the cathode side. For some cases, the water feed 220 with an added electrolyte such as dilute KOH or K₂CO₃ or a deionized water is fed to the anode side or both the cathode and the anode sides. The anode and cathode catalysts typically comprise platinum metal-free Ni-based or Ni alloy catalysts. At the negatively charged cathode 210, water is reduced to form hydrogen 225 and hydroxyl ions by the addition of four electrons; the reaction is given by Eq. 4. The hydroxyl ions diffuse from the cathode 210 to the anode 205 through the AEM 215 which conducts hydroxyl ions. At the positively charged anode 205, the hydroxyl ions recombine as water and oxygen 230; the reaction is given by Eq. 5. The AEM 215 not only conducts hydroxyl ions from the cathode 210 to the anode 205, but also separates the H₂ 225 and O₂ 230 produced in the water electrolysis reaction. The AEM 215 allows the hydrogen 225 to be produced under high pressure up to about 35 bar with very high purity of at least 99.9%.

$$Reduction reaction at cathode for AEMWE : 4 {H}_{2} O + 4 {e}^{-} \to 2 {H}_{2} + 4 {OH}^{-} \qquad ( 4 )$$

$$Oxidation reaction at anode for AEMWE : 4 {OH}^{-} \to 2 {H}_{2} O + {O}_{2} + 4 {e}^{-} \qquad ( 5 )$$

AEMWE has an advantage over PEMWE because it permits the use of less expensive platinum metal-free catalysts, such as Ni and Ni alloy catalysts. In addition, much cheaper stainless steel bipolar plates can be used in the gas diffusion layers (GDL) for AEMWE, instead of the expensive Pt-coated Ti bipolar plates currently used in PEMWE. However, the largest impediments to the development of AEM systems are membrane hydroxyl ion conductivity and stability, as well as lack of understanding of how to integrate catalysts into AEM systems. Research on AEMWE in the literature has been focused on developing electrocatalysts, AEMs, and understanding the operational mechanisms with the general objective of obtaining a high efficiency, low cost and stable AEMWE technology.

The anode in an electrochemical cell is the electrode at which the predominant reaction is oxidation (e.g., the water oxidation/oxygen evolution reaction electrode for a water electrolyzer). The cathode in an electrochemical cell is the electrode at which the predominant reaction is reduction (e.g., the proton reduction/hydrogen evolution reaction electrode for a water electrolyzer). The membrane is one of the key materials that make up an electrolysis cell and is an important driver for safety and performance. Some important properties for membranes for electrolysis include high conductivity, high ionic permeability, high ionic exchange capacity (for ion-exchange membrane), high ionic/H₂ and O₂ selectivity (low H₂ and O₂ permeability/crossover), low price, low area resistance to minimize efficiency loss resulting from ohmic polarization, high resistance to oxidizing and reducing conditions, being chemically inert at a wide pH range, high thermal stability together with high proton conductivity, and high mechanical strength (thickness, low swelling).

Recently newer cost-effective, high performance membrane materials for use with cell stack components for water electrolysis with a wide range of applications in renewable energy systems have been invented. While presumably effective for their intended purposes, it is known that hydrogen may migrate through the thin membrane and impact the effectiveness and efficiency of the cell. The H₂ crossover from the cathode stream to the anode stream also leads to safety concerns if the concentration of H₂ in O₂ reaches 2%.

Accordingly, it would be desirable to provide membranes that reduce or eliminate the amount of hydrogen flowing across the membrane.

### SUMMARY

The present invention provides an ion-exchange membrane which includes a catalyst layer on one side of the membrane. A polyelectrolyte multilayer coating is provided on the catalyst layer. The catalyst layer forms water out of the permeating hydrogen and oxygen which leads to higher gas purity and addresses safety concerns with the migrating of gases across the membrane. A radical scavenger may be included to improve the chemical/electrochemical stability of the membrane.

Therefore, in a first aspect, the present invention may be generally characterized as providing a multilayer ion-exchange membrane having: an ion-exchange membrane layer; a catalyst layer coated on a first surface of the ion-exchange membrane layer; and, a first polyelectrolyte multilayer coating coated on the catalyst layer.

The first polyelectrolyte multilayer coating may be thinner than the ion-exchange membrane layer and may include alternating layers of a polycation polymer and a polyanion polymer.

The multilayer ion-exchange membrane may further include a second polyelectrolyte multilayer coating coated on a second surface of the ion-exchange membrane layer. The first polyelectrolyte multilayer coating and the second polyelectrolyte multilayer coating may be thinner than the ion-exchange membrane layer. One or both the first polyelectrolyte multilayer coating and the second polyelectrolyte multilayer coating may include alternating layers of a polycation polymer and a polyanion polymer.

The catalyst layer may include a catalyst and an ionomer. The catalyst may include Pt, PtCo, Pd, PdCo, or mixtures thereof. The ionomer may be a proton-conductive fluorinated or non-fluorinated polymeric ionomer, or a hydroxide-conductive polymeric ionomer.

The catalyst layer may further include an additive. The additive may be CeO₂, Ce(OH)₄, CeO₂/ZrO₂, Ce(OH)₄/ZrO₂, or mixtures thereof.

The catalyst layer may be thinner than the ion-exchange membrane layer and thicker than the first polyelectrolyte multilayer coating.

In a second aspect, the present invention may be broadly characterized as providing a membrane electrode assembly having: an ion-exchange membrane layer; a catalyst layer coated on a first surface on a first side of the ion-exchange membrane layer; a first polyelectrolyte multilayer coating coated on the catalyst layer; an anode electrode disposed on a surface of the first polyelectrolyte multilayer coating; and, a cathode electrode disposed on a second side of the ion-exchange membrane layer.

The first polyelectrolyte multilayer coating may be thinner than the ion-exchange membrane layer and may include alternating layers of a polycation polymer and a polyanion polymer.

The membrane electrode assembly may include a second polyelectrolyte multilayer coating between the ion-exchange membrane layer and the cathode electrode. The second polyelectrolyte multilayer coating may be coated on a second surface on a second side of the ion-exchange membrane layer. The first polyelectrolyte multilayer coating and the second polyelectrolyte multilayer coating may be thinner than the ion-exchange membrane layer. One or both the first polyelectrolyte multilayer coating and the second polyelectrolyte multilayer coating may include alternating layers of a polycation polymer and a polyanion polymer.

The catalyst layer may include a catalyst and an ionomer. The catalyst may be Pt, PtCo, Pd, PdCo, or mixtures thereof. The ionomer may be a proton-conductive fluorinated or non-fluorinated polymeric ionomer, or a hydroxide-conductive polymeric ionomer.

The catalyst layer further comprises an additive. The additive may be CeO₂, Ce(OH)₄, CeO₂/ZrO₂, Ce(OH)₄/ZrO₂, or mixtures thereof.

The catalyst layer may be thinner than the ion-exchange membrane layer and thicker than the first polyelectrolyte multilayer coating.

In a third aspect, the present invention, broadly, may be characterized as providing a process for preparing a multilayer ion-exchange membrane by: coating a catalyst layer on a first surface of a first side of an ion-exchange membrane; and, coating a first polyelectrolyte multilayer on the catalyst layer.

The process may further include coating a second polyelectrolyte multilayer on a second surface on a second side of the ion-exchange membrane. The coating of the second polyelectrolyte multilayer may be done during or after the coating of the first polyelectrolyte multilayer.

The process may further include applying a cathode electrode on the second surface on a second side of the ion-exchange membrane.

The process may also include applying an anode electrode on the first polyelectrolyte multilayer.

Additional aspects, embodiments, and details of the invention, all of which may be combinable in any manner, are set forth in the following detailed description of the invention.

### BRIEF DESCRIPTION OF THE DRAWINGS

FIG. 1 is an illustration of one embodiment of a PEMWE cell.

FIG. 2 is an illustration of one embodiment of a AEMWE cell.

FIG. 3 is an illustration of one embodiment of a multilayer ion-exchange membrane of the present invention for PEMWE application.

FIG. 4 is an illustration of one embodiment of a multilayer ion-exchange membrane of the present invention for AEMWE application.

FIG. 5 is a graph of polarization curves of a water electrolysis cell comprising of (a) PEL-PEM-MEA; (b) PEL-H₂R-PEM-MEA; and (c) PEL-H₂RCe-PEM-MEA, respectively, at 80° C., atmospheric pressure.

### DETAILED DESCRIPTION

A new multilayer ion-exchange membrane for electrolysis applications has been developed. The multilayer ion-exchange membrane comprises an ion-exchange membrane layer, a catalyst layer coated on a first surface of the ion-exchange membrane, a first polyelectrolyte multilayer coated on the catalyst layer, and optionally a second polyelectrolyte multilayer coated on a second surface of the ion-exchange membrane.

The new multilayer ion exchange membrane reduces H₂ in O₂ content at the anode stream of the water electrolyzer by incorporating a H₂ recombination catalyst layer into the ion exchange membrane. The catalyst layer is coated to form a thin layer of the H₂ recombination catalyst layer on one surface of the base ion-exchange membrane. The H₂ recombination catalyst layer effectively lowered the H₂ crossover from the cathode stream to the anode stream and prevented the formation of an explosive H₂/O₂ mixture in the anode stream. The H₂ recombination reaction of H₂ and O₂ results in the formation of water and therefore lowers the H₂ concentration in O₂ in the anode stream. A polyelectrolyte multilayer coating is applied on the catalyst layer. These layers may be applied by dip coating, spray deposition, centrifugal deposition, electrodeposition, meniscus/slot die coating, brushing, roller coating, metering rod/Mayer bar coating, knife casting, and the like. The polyelectrolyte multilayer coating on the H₂ recombination catalyst layer is used to prevent the direct contact between the H₂ recombination catalyst and the anode catalyst when a membrane electrode assembly comprising the multilayer ion-exchange membrane, an anode, and a cathode is developed. The polyelectrolyte multilayer coating on the H₂ recombination catalyst layer also reduced the gas crossover without lowering the electrolysis performance. The new multilayer ion-exchange membrane may also include a radical scavenger such as CeO₂ or Ce(OH)₄.

The permeating H₂ and O₂ forms H₂O at the H₂ recombination catalyst layer, leading to higher gas purity and resolving safety issues. Additionally, the radical scavenger improves the membrane chemical/electrochemical stability.

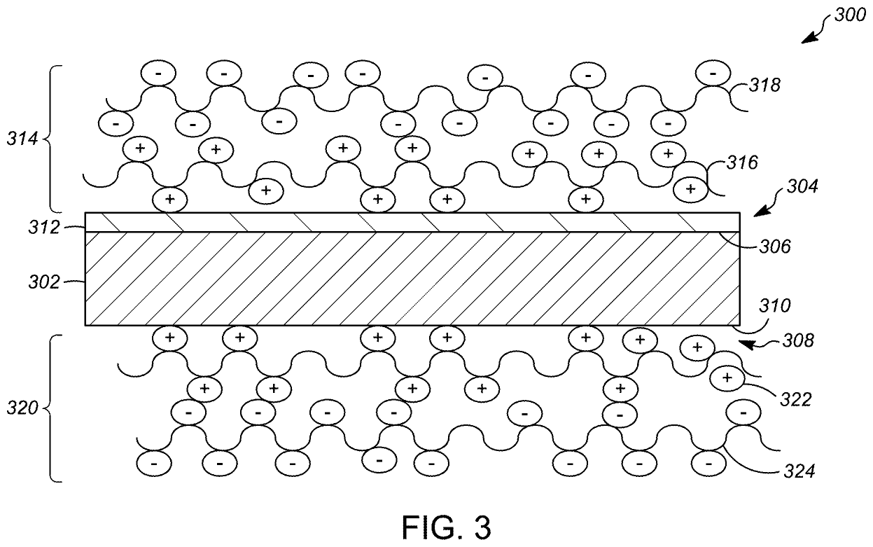

FIG. 3 is an illustration of the multilayer ion-exchange membrane 300 for PEMWE having a base ion-exchange membrane 302 having a first side 304 with a first surface 306 and a second side 308 with a second surface 310.

The ion-exchange membrane 302 comprises a cation exchange polymer or a mixture of a cation exchange polymer and an inorganic filler comprising covalently bonded acidic functional groups. The ion-exchange membrane 302 in the new multilayer improved ion-exchange membrane 300 comprises —SO₃⁻, —COO⁻, —PO₃²⁻, or —PO₃H⁻ cation exchange functional groups with negative ionic charges. The cation exchange polymer in the ion-exchange membrane 302 may be selected from, but is not limited to, a perfluorinated ionomer such as Nafion®, Flemion®, Fumion®, or Aquivion®, a cross-linked perfluorinated cation-exchange polymer, a partially fluorinated polymer, a cross-linked partially fluorinated cation-exchange polymer, a non-fluorinated hydrocarbon polymer, a cross-linked non-fluorinated hydrocarbon cation-exchange polymer, or combinations thereof. The ion-exchange membrane 302 has high mechanical strength, good chemical and thermal stability, and good proton conductivity. However, the ion-exchange membrane 302 typically has high H₂ and O₂ crossover when thinner membrane with lower cost and lower area specific resistance is used for electrolysis applications. The new multilayer ion-exchange membrane 300 has low membrane area specific resistance, low swelling, significantly reduced H₂ and O₂ crossover, and enhanced proton conductivity compared to the ion-exchange membrane 302 without the catalyst layer and the polyelectrolyte multilayer coating.

The ion-exchange membrane 302 for the preparation of the multilayer ion-exchange membrane 300 may be the composite proton conductive membrane described in U.S. patent application Ser. No. 17/162,421, filed on Jan. 29, 2021, entitled Composite Proton Conductive Membranes, which is incorporated herein by reference in its entirety. That application disclosed a new type of composite proton conductive membrane comprising an inorganic filler having covalently bonded acidic functional groups and a high surface area of at least 150 m²/g, and a water insoluble ionically conductive polymer.

The inorganic filler comprising covalently bonded acidic functional groups in the ion-exchange membrane 302 may be selected from, but is not limited to, silica gel, precipitated silica, fumed silica, colloidal silica, alumina, silica-alumina, zirconium oxide, molecular sieve, metal-organic framework, zeolitic imidazolate framework, covalent organic framework, or a combination thereof, and wherein the filler may comprise both covalently bonded acidic functional groups and a high surface area of 150 m²/g or higher, or 300 m²/g or higher, or 400 m²/g or higher. Molecular sieves have framework structures which may be characterized by distinctive wide-angle X-ray diffraction patterns. Zeolites are a subclass of molecular sieves based on an aluminosilicate composition. Non-zeolitic molecular sieves are based on other compositions such as aluminophosphates, silico-aluminophosphates, and silica. Molecular sieves can have different chemical compositions and different framework structure. The molecular sieves can be microporous or mesoporous molecular sieves and need to be stable in aqueous solution under pH of less than 6. The acidic functional groups covalently bonded to the inorganic fillers may be selected from, but are not limited to, —H₂PO₃, —R—H₂PO₃, —SO₃H, —R—SO₃H, —COOH, —R—COOH, —C₆H₅OH, —R—C₆H₅OH, or a combination thereof, wherein R represents a linear alkyl group, a branched alkyl group, a cycloalkyl group, an organoamino group, an acid group-substituted organoamino group, or an aryl group and the number of carbon atoms in these groups is preferably 1 to 20, more preferably 1 to 10. The inorganic fillers may be in the form of, but are not limited to, particles, fine beads, thin plates, rods, or fibers. The size of the inorganic filler is in a range of about 2 nm to about 200 μm, or in a range of about 10 nm to about 100 μm, or in a range of about 50 nm to about 80 μm. In some embodiments, the inorganic filler is aminopropyl-N,N-bis(methyl phosphonic acid)-functionalized silica gel such as SilicaMetS® AMPA, aminopropyl-N,N-bis(methyl phosphonic acid)-functionalized fumed silica, n-propyl phosphonic acid-functionalized silica gel, n-propyl phosphonic acid-functionalized fumed silica, p-toluenesulfonic acid-functionalized silica gel, p-toluenesulfonic acid-functionalized fumed silica, 4-ethylbenzenesulfonic acid-functionalized silica gel such as SilicaBond® Tosic Acid, 4-ethylbenzenesulfonic acid-functionalized fumed silica, n-propyl sulfonic acid-functionalized silica gel, n-propyl sulfonic acid-functionalized fumed silica, or combinations thereof.

Suitable cation exchange polymers include, but are not limited to, a perfluorinated sulfonic acid-based polymer, a perfluorinated carboxylic acid polymer, a sulfonated aromatic hydrocarbon polymer, a cross-linked sulfonated aromatic hydrocarbon polymer, or combinations thereof. Suitable cation exchange polymers include, but are not limited to, a copolymer of tetrafluoroethylene and perfluoro-3,6-dioxa-4-methyl-7-octene-sulfonic acid, a copolymer of tetrafluoroethylene and perfluoro-5-oxa-6-heptene-sulfonic acid, a copolymer of tetrafluoroethylene and perfluoro-4-oxa-5-hexene-sulfonic acid, a copolymer of tetrafluoroethylene and perfluoro-3-oxa-4-pentene-sulfonic acid, a copolymer of perfluoro-3,6-dioxa-4-methyl-7-octene-sulfonic acid and perfluoro(2,2-dimethyl-1,3-dioxole), a copolymer of perfluoro-5-oxa-6-heptene-sulfonic acid and perfluoro(2,2-dimethyl-1,3-dioxole), a copolymer of perfluoro-4-oxa-5-hexene-sulfonic acid and perfluoro(2,2-dimethyl-1,3-dioxole), a copolymer of perfluoro-3-oxa-4-pentene-sulfonic acid and perfluoro(2,2-dimethyl-1,3-dioxole), a copolymer of perfluoro-3,6-dioxa-4-methyl-7-octene-sulfonic acid and perfluoro(2-methylene-4-methyl-1,3-dioxolane), a copolymer of perfluoro-5-oxa-6-heptene-sulfonic acid and perfluoro(2-methylene-4-methyl-1,3-dioxolane), a copolymer of perfluoro-4-oxa-5-hexene-sulfonic acid and perfluoro(2-methylene-4-methyl-1,3-dioxolane), a copolymer of perfluoro-3-oxa-4-pentene-sulfonic acid and perfluoro(2-methylene-4-methyl-1,3-dioxolane), a copolymer of perfluoro-3,6-dioxa-4-methyl-7-octene-sulfonic acid and 2,2,4-trifluoro-5-trifluoromethoxy-1,3-dioxole, a copolymer of perfluoro-5-oxa-6-heptene-sulfonic acid and 2,2,4-trifluoro-5-trifluoromethoxy-1,3-dioxole, a copolymer of perfluoro-4-oxa-5-hexene-sulfonic acid and 2,2,4-trifluoro-5-trifluoromethoxy-1,3-dioxole, a copolymer of perfluoro-3-oxa-4-pentene-sulfonic acid and 2,2,4-trifluoro-5-trifluoromethoxy-1,3-dioxole, sulfonated poly(ether ether ketone) (SPEEK), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), cross-linked SPEEK, cross-linked sulfonated polyether sulfone, cross-linked sulfonated polyphenyl sulfone, crosslinked poly(phenylene sulfide sulfone nitrile), sulfonated polystyrene, sulfonated poly(vinyl toluene), cross-linked sulfonated polystyrene, cross-linked sulfonated poly(vinyl toluene), or combinations thereof.

The new multilayer ion-exchange membrane 300 includes a catalyst layer 312 applied on the first surface 306 of the ion-exchange membrane 302. The catalyst layer 312 may include a catalyst and an ionomer. The catalyst is for a hydrogen recombination reaction and may be Pt, Pt/Co, Pd, Pd/Co, and mixtures thereof. The ionomer may be a proton-conductive fluorinated or non-fluorinated polymeric ionomer.

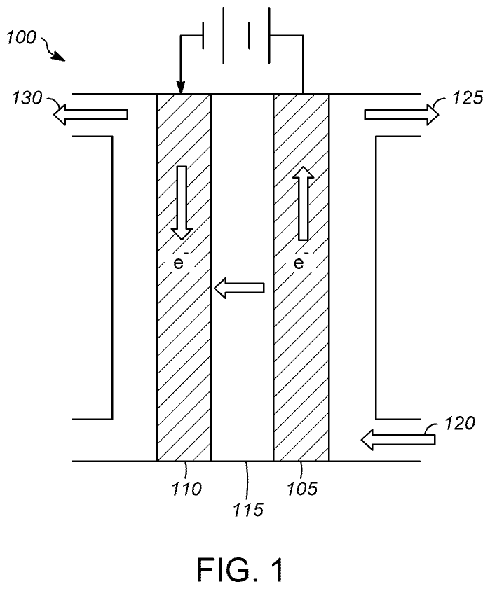

The catalyst layer 312 may further include an additive such as CeO₂, Ce(OH)₄, CeO₂/ZrO₂, Ce(OH)₄/ZrO₂, or mixtures thereof. These additives, such as CeO₂, Ce(OH)₄, CeO₂/ZrO₂, Ce(OH)₄/ZrO₂, or mixtures thereof, are radial scavengers with active redox couple of Ce(IV)/Ce(III). The catalytic H₂ recombination reaction in the H₂ recombination catalyst layer 312 and the catalytic reactions in the cathode 110 as shown in in FIG. 1 in the presence of O₂ also generate hydrogen peroxide and radical intermediates, such as hydroperoxyl (HOO·) and hydroxyl (HO·) radicals. These reactive oxygen species result in membrane and ionomer degradation. The incorporation of the radical scavenger into the H₂ recombination catalyst layer provides improved durability of the multilayer ion-exchange membrane.

On the catalyst layer 312, there is a polyeletrolyte multilayer coating 314 that may include alternating layers of a polycation polymer 316 and a polyanion polymer 318. There may be a second polyelectrolyte multilayer coating 320 comprising alternating layers of a polycation polymer 322 and a polyanion polymer 324 on the second surface 310 of the ion-exchange membrane 302.

The first layer of the polyelectrolyte layers 314 deposited on the catalyst layer 312 should be a polycation polymer layer having positive ionic charges, opposite from those on the ionomers in the catalyst layer 312. This leads to the formation of a stable polyelectrolyte coating via electrostatic interactions between the catalyst layer 312 and the polyelectrolyte coating 316.

A polyanion polymer with opposite charges is then deposited on the surface of the first polycation polymer coating layer via electrostatic interactions to form the second part of the first polyelectrolyte bilayer. Polyelectrolyte multilayers can be formed following the same alternating deposition process.

The first layer of the polyelectrolyte layers 322 optionally deposited on the second surface of the ion-exchange membrane 302 should be a polycation polymer layer having positive ionic charges, opposite from those on the ion-exchange membrane layer 302. This leads to the formation of a stable polyelectrolyte coating via electrostatic interactions between the ion-exchange membrane layer 302 and the polyelectrolyte coating 322.

A polyanion polymer with opposite charges is then deposited on the surface of the first polycation polymer coating layer 322 via electrostatic interactions to form the second part of the first polyelectrolyte bilayer. Polyelectrolyte multilayers can be formed following the same alternating deposition process.

The thickness of each layer 318, 316, 322, 324 of the polyanion or polycation may be less than 50 nm, or less than 20 nm, or less than 10 nm, or less than 5 nm.

The first polyelectrolyte multilayer coating 314 may be thinner than the ion exchange membrane 302. Additionally, the first polyelectrolyte multilayer coating 314 and the second polyelectrolyte multilayer coating 320 may be thinner than the ion exchange membrane 302. The catalyst layer 312 may be thinner than the ion exchange membrane layer 302 and thicker than the first polyelectrolyte multilayer 314.

The polyanion polymer in the polyelectrolyte multilayers 314, 320 has negative charges and can be the same or different from the cation exchange polymer in the ion exchange membrane 302, but the polyanion polymer cannot be the first polyelectrolyte layer deposited on the surface of the cation exchange membrane having negative charges. The polyanion polymer suitable for the preparation of the multilayer ion-exchange membrane has similar or higher proton conductivity than the cation exchange membrane and has similar or lower intrinsic H₂ and O₂ permeabilities than the cation exchange membrane. However, the polyanion polymer and the polycation polymer may be soluble in aqueous solutions, which makes the membranes prepared from either the polyanion polymer or polyanion polymer unsuitable for water electrolysis or fuel cell applications. The polyelectrolyte layers 314, 320 deposited on the catalyst layer 312 and the ion exchange membrane 302 via layer-by-layer self-assembly are not only insoluble and thermally and chemically stable, but also have significantly reduced swelling and H₂ and O₂ crossover of the cation exchange membrane, and enhanced proton conductivity compared to the cation exchange membrane for water electrolysis applications.

The polycation polymers suitable for the preparation of the multilayer ion-exchange membrane 300 include, but are not limited to protonated chitosan; an amine based linear, hyperbranched, or dendritic polycation polymer selected from the group consisting of polybiguanide, quaternary ammonium polyethylenimine, quaternary ammonium polypropylenimine, quaternary ammonium polyamidoamine (PAMAM), poly(vinylamine hydrochloride) (PVH), poly(allylamine hydrochloride) (PAH), poly(amidoamine hydrochloride), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly(4-vinylpiperidine hydrochloride), poly(diallyldimethylammonium chloride), poly(acrylamide-co-diallyldimethylammonium chloride), poly(diallyl methyl amine hydrochloride), a copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(1-lysine), poly(2-methacryloyloxyethyl phosphorylcholine methacrylate)-block-poly(vinyl benzyl trimethylammonium chloride), poly [2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate]; or combinations thereof.

The polyanion polymers suitable for the preparation of the multilayer ion-exchange membrane 300 include but, are not limited to, a sulfonated hydrocarbon polymer, poly(acrylic acid), poly(sodium phosphate), or a negatively charged polysaccharide polyanion polymer, or combinations thereof. Suitable sulfonated hydrocarbon polymers include, but are not limited to, sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated polystyrene, sulfonated poly(vinyl toluene), poly(acrylic acid), poly(vinylsulfonic acid sodium), poly(sodium phosphate), or combinations thereof. Suitable negatively charged polysaccharide polyanion polymers include, but are not limited to, sodium alginate, potassium alginate, calcium alginate, ammonium alginate, alginic acid, sodium hyaluronate, potassium hyaluronate, calcium hyaluronate, ammonium hyaluronate, hyaluronic acid, x-carrageenan, X-carrageenan, t-carrageenan, carboxymethyl curdlan, sodium carboxymethyl curdlan, potassium carboxymethyl curdlan, calcium carboxymethyl curdlan, ammonium carboxymethyl curdlan, carboxymethyl cellulose, sodium carboxymethyl cellulose, potassium carboxymethyl cellulose, calcium carboxymethyl cellulose, ammonium carboxymethyl cellulose, or combinations thereof.

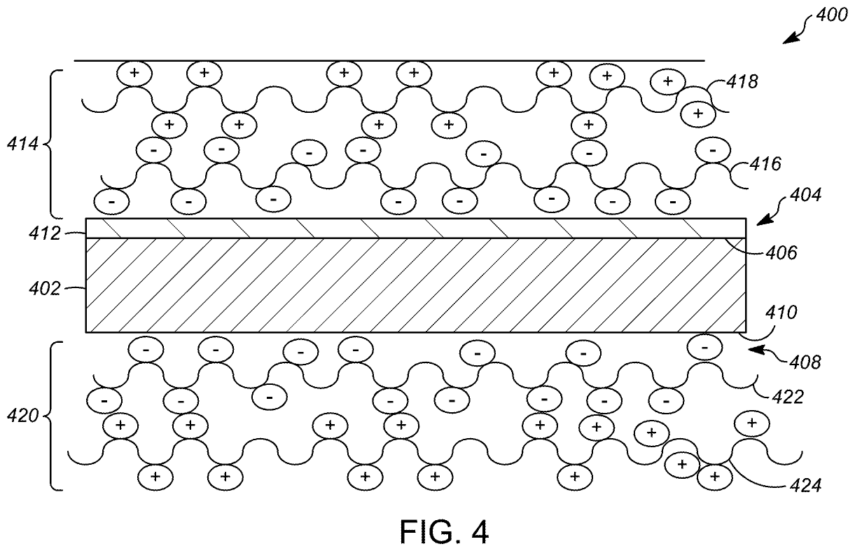

FIG. 4 is an illustration of the multilayer ion-exchange membrane 400 for AEMWE having a base ion-exchange membrane 402 having a first side 404 with a first surface 406 and a second side 408 with a second surface 410. The ion-exchange membrane 402 is an anion-exchange membrane comprising an anion exchange polymer. The ion-exchange membrane 402 in the new multilayer improved ion-exchange membrane 400 comprises anion exchange functional groups with positive ionic charges, like piperidinium, quaternized carbazole derivative, quaternized phenothiazine derivative, or piperidinium salt. The anion exchange polymer in the ion-exchange membrane 402 not only has stable hydrophobic polymer backbones comprising linear aromatic units, such as biphenyl and terphenyl, and/or polycyclic aromatic units, such as naphthalene and phenanthrene, but also has cationic groups, like piperidinium, quaternized carbazole derivative, quaternized phenothiazine derivative, or piperidinium salt, covalently incorporated into the polymer. The ion-exchange membrane 402 has high mechanical strength, good chemical and thermal stability, high OH⁻ conductivity, and low swelling in the electrolyzer. The new multilayer ion-exchange membrane 400 has low membrane area specific resistance, low swelling, significantly reduced H₂ and O₂ crossover, and enhanced OH⁻ conductivity compared to the ion-exchange membrane 402 without the catalyst layer and the polyelectrolyte multilayer coating.

The ion-exchange membrane 402 for the preparation of the multilayer ion-exchange membrane 400 may be the anion exchange membrane described in U.S. patent application Ser. No. 17/474,198, filed on Sep. 14, 2021, entitled Anion Exchange Polymers and Membranes for Electrolysis, which is incorporated herein by reference in its entirety. The ion-exchange membrane 402 for the preparation of the multilayer ion-exchange membrane 400 may be the anion exchange membrane described in U.S. patent application Ser. No. 17/662,676, filed on May 10, 2022, entitled Anion Exchange Polymers and Membranes for Electrolysis, which is incorporated herein by reference in its entirety. The ion-exchange membrane 402 for the preparation of the multilayer ion-exchange membrane 400 may be the anion exchange membrane described in U.S. patent application Ser. No. 17/823,975, filed on Sep. 1, 2022, entitled Anion Exchange Polymers and Membranes for Electrolysis, which is incorporated herein by reference in its entirety.

The new multilayer ion-exchange membrane 400 includes a catalyst layer 412 applied on the first surface 406 of the ion-exchange membrane 402. The catalyst layer 412 may include a catalyst and an ionomer. The catalyst is for a hydrogen recombination reaction and may be Pt, Pt/Co, Pd, Pd/Co, and mixtures thereof. The ionomer may be a hydroxide-conductive polymeric ionomer.

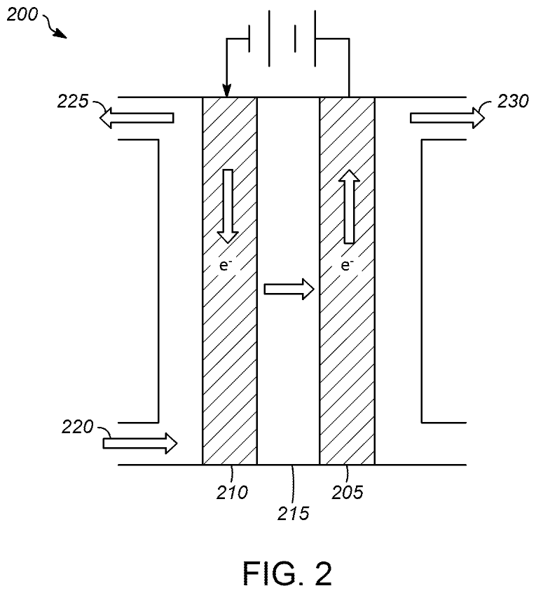

The catalyst layer 412 may further include an additive such as CeO₂, Ce(OH)₄, CeO₂/ZrO₂, Ce(OH)₄/ZrO₂, or mixtures thereof. These additives, such as CeO₂, Ce(OH)₄, CeO₂/ZrO₂, Ce(OH)₄/ZrO₂, or mixtures thereof, are radial scavengers with active redox couple of Ce(IV)/Ce(III). The catalytic H₂ recombination reaction in the H₂ recombination catalyst layer 412 and the catalytic reactions in the cathode 210 as shown in in FIG. 2 in the presence of O₂ also generate hydrogen peroxide and radical intermediates, such as hydroperoxyl (HOO·) and hydroxyl (HO·) radicals. These reactive oxygen species result in membrane and ionomer degradation. The incorporation of the radical scavenger into the H₂ recombination catalyst layer provides improved durability of the multilayer ion-exchange membrane.

On the catalyst layer 412, there is a polyeletrolyte multilayer coating 414 that may include alternating layers of a polyanion polymer 416 and a polycation polymer 418. There may be a second polyeletrolyte multilayer coating 420 comprising alternating layers of a polyanion polymer 422 and a polycation polymer 424 on the second surface 410 of the ion-exchange membrane 402.

The first layer of the polyelectrolyte layers 414 deposited on the catalyst layer 412 should be a polyanion polymer layer having negative ionic charges, opposite from those on the ionomers in the catalyst layer 412. This leads to the formation of a stable polyelectrolyte coating via electrostatic interactions between the catalyst layer 412 and the polyelectrolyte coating 416.

A polycation polymer with opposite charges is then deposited on the surface of the first polyanion polymer coating layer via electrostatic interactions to form the second part of the first polyelectrolyte bilayer. Polyelectrolyte multilayers can be formed following the same alternating deposition process.

The first layer of the polyelectrolyte layers 422 optionally deposited on the second surface of the ion-exchange membrane 402 should be a polyanion polymer layer having negative ionic charges, opposite from those on the ion-exchange membrane layer 402. This leads to the formation of a stable polyelectrolyte coating via electrostatic interactions between the ion-exchange membrane layer 402 and the polyelectrolyte coating 422.

A polycation polymer with opposite charges is then deposited on the surface of the first polyanion polymer coating layer 422 via electrostatic interactions to form the second part of the first polyelectrolyte bilayer. Polyelectrolyte multilayers can be formed following the same alternating deposition process.

The thickness of each layer 418, 416, 422, 424 of the polycation or polyanion may be less than 50 nm, or less than 20 nm, or less than 10 nm, or less than 5 nm.

The first polyelectrolyte multilayer coating 414 may be thinner than the ion exchange membrane 402. Additionally, the first polyelectrolyte multilayer coating 414 and the second polyelectrolyte multilayer coating 420 may be thinner than the ion exchange membrane 402. The catalyst layer 412 may be thinner than the ion exchange membrane layer 402 and thicker than the first polyelectrolyte multilayer 414.

The polycation polymer in the polyelectrolyte multilayers 414, 420 has positive charges and can be the same or different from the anion exchange polymer in the ion exchange membrane 402, but the polycation polymer cannot be the first polyelectrolyte layer deposited on the surface of the anion exchange membrane having positive charges. The polycation polymer suitable for the preparation of the multilayer ion-exchange membrane 400 has similar or higher hydroxide conductivity than the anion exchange membrane 402 and has similar or lower intrinsic H₂ and O₂ permeabilities than the anion exchange membrane 402. However, the polyanion polymer and the polycation polymer may be soluble in aqueous solutions, which makes the membranes prepared from either the polyanion polymer or polyanion polymer unsuitable for water electrolysis or fuel cell applications. The polyelectrolyte layers 414, 420 deposited on the catalyst layer 412 and the ion exchange membrane 402 via layer-by-layer self-assembly are not only insoluble and thermally and chemically stable, but also have significantly reduced swelling and H₂ and O₂ crossover of the anion exchange membrane 402, and enhanced hydroxide conductivity compared to the anion exchange membrane 402 for water electrolysis applications.

The polycation polymers suitable for the preparation of the multilayer ion-exchange membrane 400 include, but are not limited to protonated chitosan; an amine based linear, hyperbranched, or dendritic polycation polymer selected from the group consisting of polybiguanide, quaternary ammonium polyethylenimine, quaternary ammonium polypropylenimine, quaternary ammonium polyamidoamine (PAMAM), poly(vinylamine hydrochloride) (PVH), poly(allylamine hydrochloride) (PAH), poly(amidoamine hydrochloride), poly(N-isopropylallylamine hydrochloride), poly(N-tert-butylallylamine hydrochloride), poly(N-1,2-dimethylpropylallylamine hydrochloride), poly(N-methylallylamine hydrochloride), poly(N,N-dimethylallylamine hydrochloride), poly(2-vinylpiperidine hydrochloride), poly(4-vinylpiperidine hydrochloride), poly(diallyldimethylammonium chloride), poly(acrylamide-co-diallyldimethylammonium chloride), poly(diallyl methyl amine hydrochloride), a copolymer of 2-propen-1-amine-hydrochloride with N-2-propenyl-2-propen-1-aminehydrochloride, poly(N-alkyl-4-vinylpyridinium) salt, polylysine, polyornithine, polyarginine, poly(ethylene oxide)-block-poly(vinyl benzyl trimethylammonium chloride), poly(ethylene oxide)-block-poly(1-lysine), poly(2-methacryloyloxyethyl phosphorylcholine methacrylate)-block-poly(vinyl benzyl trimethylammonium chloride), poly[2-(dimethylamino)-ethyl methacrylate, poly[3-(dimethylamino)-propyl methacrylate], poly[2-(dimethylamino)-ethyl methacrylamide], poly[3-(dimethylamino) propyl methacrylamide], poly[2-(trimethylamino) ethyl methacrylate chloride], poly[2-(diethylamino)ethyl methacrylate], poly[2-(dimethylamino)ethyl acrylate]; or combinations thereof.

The polyanion polymers suitable for the preparation of the multilayer ion-exchange membrane 400 include but, are not limited to, a sulfonated hydrocarbon polymer, poly(acrylic acid), poly(sodium phosphate), or a negatively charged polysaccharide polyanion polymer, or combinations thereof. Suitable sulfonated hydrocarbon polymers include, but are not limited to, sulfonated poly(ether ether ketone), sulfonated polyether sulfone, sulfonated polyphenyl sulfone, sulfonated poly(2,6-dimethyl-1,4-phenylene oxide), sulfonated poly(4-phenoxybenzoyl-1,4-phenylene), sulfonated polyphenylene oxide, sulfonated poly(phenylene), sulfonated poly(phthalazinone), sulfonated polystyrene, sulfonated poly(vinyl toluene), poly(acrylic acid), poly(vinylsulfonic acid sodium), poly(sodium phosphate), or combinations thereof. Suitable negatively charged polysaccharide polyanion polymers include, but are not limited to, sodium alginate, potassium alginate, calcium alginate, ammonium alginate, alginic acid, sodium hyaluronate, potassium hyaluronate, calcium hyaluronate, ammonium hyaluronate, hyaluronic acid, x-carrageenan, X-carrageenan, t-carrageenan, carboxymethyl curdlan, sodium carboxymethyl curdlan, potassium carboxymethyl curdlan, calcium carboxymethyl curdlan, ammonium carboxymethyl curdlan, carboxymethyl cellulose, sodium carboxymethyl cellulose, potassium carboxymethyl cellulose, calcium carboxymethyl cellulose, ammonium carboxymethyl cellulose, or combinations thereof.

Another aspect of the invention is a membrane electrode assembly. In one embodiment, the membrane electrode assembly comprises: an ion-exchange membrane layer, a catalyst layer coated on a first surface on a first side of the ion-exchange membrane, a first polyelectrolyte multilayer coated on the catalyst layer, an anode electrode disposed on the surface of the first polyelectrolyte multilayer, and a cathode electrode disposed on a second side of the ion-exchange membrane.

In some embodiments, the catalyst layer of the membrane electrode assembly comprises a catalyst and an ionomer. The catalyst may comprise Pt, PtCo, Pd, PdCo, or mixtures thereof. The ionomer may comprise a proton-conductive fluorinated or non-fluorinated polymeric ionomer, or a hydroxide-conductive polymeric ionomer.

In some embodiments, the catalyst layer of the membrane electrode assembly further comprises an additive. The additive may comprise CeO₂, Ce(OH)₄, CeO₂/ZrO₂, Ce(OH)₄/ZrO₂, or mixtures thereof.

In some embodiments, the catalyst layer of the membrane electrode assembly is thinner than the ion-exchange membrane layer and thicker than the first polyelectrolyte multilayer.

In some embodiments, the membrane electrode assembly further comprises: a second polyelectrolyte multilayer between the ion-exchange membrane and the cathode electrode and coated on a second surface on a second side of the ion-exchange membrane.

In some embodiments, the first polyelectrolyte multilayer coating of the membrane electrode assembly is thinner than the ion-exchange membrane and comprises alternating layers of a polycation polymer and a polyanion polymer.

In some embodiments, the first polyelectrolyte multilayer coating and the second polyelectrolyte multilayer coating are thinner than the ion-exchange membrane.

In some embodiments, both the first polyelectrolyte multilayer coating and the second polyelectrolyte multilayer coating comprise alternating layers of a polycation polymer and a polyanion polymer.

In some embodiments, the membrane electrode assembly further comprises: an anode porous transport layer adjacent to the anode; and a cathode porous transport layer adjacent to the cathode. In some embodiments, the anode and the cathode catalysts are platinum group metal (PGM) electrocatalysts or PGM-free electrocatalysts. The anode and the cathode catalysts are for oxygen evolution reaction and hydrogen evolution reaction, respectively. The anode and the cathode catalysts should have good electrical conductivity, and good electrocatalytic activity and stability. Suitable PGM cathode catalysts can be selected from, but are not limited to, platinum, ruthenium, osmium, rhodium, palladium, tin, tungsten, vanadium, cobalt, silver, gold, nickel, molybdenum, iron, copper, chromium, alloys thereof, oxides thereof, carbides thereof, phosphides thereof, or combinations thereof. Suitable PGM anode catalysts can be selected from, but are not limited to, iridium, platinum, ruthenium, osmium, rhodium, palladium, tin, tungsten, vanadium, cobalt, silver, gold, copper, nickel, molybdenum, iron, chromium, alloys thereof, oxides thereof, carbides thereof, phosphides thereof, or combinations thereof. Suitable PGM-free cathode catalysts can be selected from, but are not limited to, Ni-based alloys such as Ni—Mo, Ni—Al, Ni—Cr, Ni—Sn, Ni—Co, Ni—W, and Ni—Al—Mo, metal carbides such as Mo₂C, metal phosphides such as CoP, metal dichalcogenides such as MoSe₂, and mixtures thereof. Suitable PGM-free anode catalysts can be selected from, but are not limited to, Ni—Fe alloy, Ni—Mo alloy, spinel CuₓCo₃ₓO₃, Ni—Fe layered double hydroxide nanoplates on carbon nanotubes, immobilized metal catalyst on conductive supports, and mixtures thereof.

The anode porous transport layer and the cathode porous transport layer simultaneously transport electrons, heat, and products with minimum voltage, current, thermal, interfacial, and fluidic losses. The cathode porous transport layer can be made from, but is not limited to, stainless steel, titanium meshes, titanium felts, titanium foams, or carbon-based materials such as non-woven carbon paper, non-woven carbon cloth, or woven carbon cloth. The anode porous transport layer can be made from, but is not limited to, stainless steel, titanium meshes, titanium felts, or titanium foams.

Another embodiment of the invention is a process of preparing the multilayer ion-exchange membrane comprising coating a catalyst layer on a first surface of a first side of an ion-exchange membrane and coating a first polyelectrolyte multilayer on the catalyst layer.

In some embodiments, the process of preparing the multilayer ion-exchange membrane further comprises coating a second polyelectrolyte multilayer on a second surface on a second side of the ion-exchange membrane, wherein the coating of the second polyelectrolyte multilayer is during or after the coating of the first polyelectrolyte multilayer.

In some embodiments, the catalyst layer is formed by coating the catalyst ink on the first surface of the first side of the ion-exchange membrane via meniscus coating, dip coating, slot die coating, brushing, knife coating, spray coating, painting, metering rod/Mayer bar coating, or other known conventional ink coating technologies, followed by drying the coated membrane.

In some embodiments, the first polyelectrolyte multilayer on the catalyst layer is formed by applying a polyelectrolyte multilayer coating to the catalyst layer, and the polyelectrolyte multilayer coating comprising alternating layers of a polycation polymer and a polyanion polymer, and optionally treating the coated membrane in an acidic solution. There are at least two sets of alternating layers of the polycation polymer and the polyanion polymer on the surface of the catalyst layer. The first polyelectrolyte multilayer may be formed by coating the alternating layers of the polycation polymer and the polyanion polymer via layer-by-layer deposition, meniscus coating, dip coating, centrifugal deposition, slot die coating, brushing, knife coating, spray coating, painting, metering rod/Mayer bar coating, or other known conventional coating technologies, followed by drying the coated membrane. The second polyelectrolyte multilayer on the second surface on the second side of the ion-exchange membrane may be formed by coating the alternating layers of the polycation polymer and the polyanion polymer via layer-by-layer deposition, meniscus coating, dip coating, centrifugal deposition, slot die coating, brushing, knife coating, spray coating, painting, metering rod/Mayer bar coating, or other known conventional coating technologies, followed by drying the coated membrane.

Another embodiment of the invention is a process of preparing the membrane electrode assembly comprising a multiplayer ion-exchange membrane comprising an ion-exchange membrane layer, a catalyst layer coated on a first surface on a first side of the ion-exchange membrane, a first polyelectrolyte multilayer coated on the catalyst layer, an anode electrode disposed on the surface of the first polyelectrolyte multilayer, and a cathode electrode disposed on a second side of the ion-exchange membrane.

In some embodiments, the anode electrode is formed by coating an anode catalyst ink on the surface of the first polyelectrolyte multilayer via meniscus coating, dip coating, slot die coating, brushing, knife coating, spray coating, painting, metering rod/Mayer bar coating, or other known conventional ink coating technologies, followed by drying the coated membrane at a temperature in a range of 40° C. to 80° C.

In some embodiments, the cathode electrode is formed by coating a cathode catalyst ink on the second side of the ion-exchange membrane via meniscus coating, dip coating, slot die coating, brushing, knife coating, spray coating, painting, metering rod/Mayer bar coating, or other known conventional ink coating technologies, followed by drying the coated membrane at a temperature in a range of 40° C. to 80° C.

In some embodiments, the membrane electrode assembly may be annealed at a temperature in a range of 90° C. to 150° C. after drying the membrane electrode assembly.

In some embodiments, the anode catalyst ink comprises the anode catalyst, an ionomer, and a solvent. In some embodiments, the cathode catalyst ink comprises the cathode catalyst, an ionomer, and a solvent. The ionomer creates proton or hydroxide transport pathways between the membrane and the reaction sites within the electrodes and thus drastically improves the utilization of the electrocatalyst particles while reducing the internal resistance. The solvent may be selected from, but is not limited to, water, alcohol, acetone, methyl ethyl ketone, an ether such as diethyl ether or di-n-propyl ether, tetrahydrofuran, 1,3-dioxolane, methyl acetate, ethyl acetate, dimethyl sulfoxide, dimethylacetamide, dimethylformamide, or combinations thereof. Suitable alcohols include, but are not limited to, methanol, ethanol, 1-propanol, 2-propanol, 1-butanol, 2-butanol, iso-butanol, or tert-butanol, or combinations thereof.

Another embodiment of the invention is the use of the multilayer ion-exchange membrane comprising an ion-exchange membrane, a catalyst layer on a first surface of a first side of the ion-exchange membrane, and a first polyelectrolyte multilayer on the catalyst layer for electrolysis applications such as water electrolysis, CO₂ electrolysis, and co-electrolysis of water and CO₂.

### EXAMPLES

The following examples are provided to illustrate one or more preferred embodiments of the invention but are not limited embodiments thereof. Numerous variations can be made to the following examples that lie within the scope of the invention.

### Comparative Example 1. Preparation of a Polyelectrolyte Multilayer-Coated Cation-Exchange Membrane without a H₂ Recombination Catalyst Layer (Abbreviated as PEL-PEM)

A poly(allylamine hydrochloride) (PAH) and sulfonated poly(ether ether ketone) (SPEEK) polyelectrolyte multilayer-coated Nafion® 212 membrane (abbreviated as PEL-PEM) was prepared as the following: A PAH polycation solution with NaCl and PAH was prepared by dissolving NaCl and PAH in deionized (DI) H₂O and adjusting the pH to 2.3 using a HCl aqueous solution. A SPEEK polyanion aqueous solution with NaCl and SPEEK was prepared by dissolving the NaCl and SPEEK in DI H₂O at 80° C. After cooling down to room temperature, the solution was filtered, and the pH was adjusted to 5.8. A piece of Nafion® 212 membrane was immersed in the PAH polycation solution for 5 min, and the membrane was rinsed with DI H₂O 3 times. The membrane was then immersed in the SPEEK polyanion solution for 5 min. The membrane was rinsed with DI H₂O 3 times and one PAH/SPEEK polyelectrolyte bilayer was deposited on the surfaces of the Nafion® 212 membrane. This process was repeated to deposit 3 sets of PAH/SPEEK polyelectrolyte bilayers on the surfaces of the Nafion® 212 membrane to form PEL-PEM membrane.

### Comparative Example 2. Preparation of a Membrane Electrode Assembly Comprising PEL-PEM Membrane (Abbreviated as PEL-PEM-MEA)

An anode catalyst ink was prepared by mixing IrO₂, an additive solution of poly(3,4-ethylenedioxythiophene) (PEDOT) and poly(styrenesulfonate) (PSS), Nafion® ionomer D2021 solution, H₂O, and ethanol. The mixture was finely dispersed using an ultrasonication bath and ultrasonication probe. The anode catalyst ink was coated onto a first surface of the PEL-PEM membrane using a Mayer rod coating method. The anode IrO₂ loading was about 1.0 mg/cm².

A cathode catalyst ink was prepared by mixing 40% Pt/C catalyst, Nafion® ionomer in H₂O and ethanol. The mixture was finely dispersed using an ultrasonication bath and ultrasonication probe. The cathode catalyst ink was coated onto a second surface of the PEL-PEM membrane using a Mayer rod coating method to form a three-layer membrane electrode assembly (abbreviated PEL-PEM-MEA). The cathode Pt loading was about 0.2 mg/cm².

### Example 1. Preparation of a Multilayer Cation-Exchange Membrane Comprising a Polyelectrolyte Multilayer and a H₂ Recombination Catalyst Layer (Abbreviated as PEL-H₂R-PEM)

A PAH and SPEEK polyelectrolyte multilayer and a H₂R catalyst layer-coated membrane (abbreviated as PEL-H₂R-PEM) was prepared as the following: A H₂ recombination (H₂R) catalyst ink was prepared by mixing Pt black catalyst, Nafion® D2021 ionomer solution, H₂O, and ethanol. The mixture was finely dispersed using an ultrasonication bath and ultrasonication probe. The H₂R catalyst ink was coated onto a first surface of the Nafion® 212 membrane using a Mayer rod coating method to form a H₂R layer-coated Nafion® 212 membrane. The Pt loading in the H₂R catalyst layer was about 0.05 mg/cm².

A PAH polycation solution with NaCl and PAH was prepared by dissolving NaCl and PAH in deionized (DI) H₂O and adjusting the pH to 2.3 using a HCl aqueous solution. A SPEEK polyanion aqueous solution with NaCl and SPEEK was prepared by dissolving the NaCl and SPEEK in DI H₂O at 80° C. After cooling down to room temperature, the solution was filtered, and the pH was adjusted to 5.8. The H₂R layer on the H₂R layer-coated Nafion® 212 membrane with the other surface of the membrane covered was immersed in the PAH polycation solution for 5 min, and the membrane was rinsed with DI H₂O 3 times. The membrane was then immersed in the SPEEK polyanion solution for 5 min. The membrane was rinsed with DI H₂O 3 times and one PAH/SPEEK polyelectrolyte bilayer was deposited on the surfaces of the H₂R layer on the H₂R layer-coated Nafion® 212 membrane. This process was repeated to deposit 3 sets of PAH/SPEEK polyelectrolyte bilayers on the surfaces of the H₂R layer on the H₂R layer-coated Nafion® 212 membrane to form PEL-H₂R-PEM membrane.

### Example 2. Preparation of a Membrane Electrode Assembly Comprising PEL-H₂R-PEM Membrane (Abbreviated as PEL-H₂R-PEM-MEA)

An anode catalyst ink was prepared by mixing IrO₂, an additive solution of poly(3,4-ethylenedioxythiophene) (PEDOT) and poly(styrenesulfonate) (PSS), Nafion® ionomer D2021 solution, H₂O, and ethanol. The mixture was finely dispersed using an ultrasonication bath and ultrasonication probe. The anode catalyst ink was coated onto the surface of the PAH/SPEEK polyelectrolyte bilayers of the PEL-H₂R-PEM membrane using a Mayer rod coating method. The anode IrO₂ loading was about 1.0 mg/cm².

A cathode catalyst ink was prepared by mixing 40% Pt/C catalyst, Nafion® ionomer D2021 solution, H₂O, and ethanol. The mixture was finely dispersed using an ultrasonication bath and ultrasonication probe. The cathode catalyst ink was coated onto a second surface of the PEL-H₂R-PEM membrane using a Mayer rod coating method to form a three-layer membrane electrode assembly (abbreviated PEL-H₂R-PEM-MEA). The cathode Pt loading was about 0.2 mg/cm².

### Example 3. Preparation of a Multilayer Cation-Exchange Membrane Comprising a Polyelectrolyte Multilayer, a H₂ Recombination Catalyst Layer, and CeO₂ in the H₂ Recombination Catalyst Layer (Abbreviated as PEL-H₂RCe-PEM)

A PAH and SPEEK polyelectrolyte multilayer and a H₂R catalyst layer comprising Pt and CeO₂-coated membrane (abbreviated as PEL-H₂RCe-PEM) was prepared as the following: A H₂ recombination (H₂R) catalyst ink comprising Pt and CeO₂ was prepared by mixing Pt black catalyst, CeO₂, Nafion® D2021 ionomer solution, H₂O, and ethanol. The mixture was finely dispersed using an ultrasonication bath and ultrasonication probe. The H₂R catalyst ink comprising Pt and CeO₂ was coated onto a first surface of the Nafion® 212 membrane using a Mayer rod coating method to form a Pt and CeO₂-coated Nafion® 212 membrane. The Pt loading in the H₂R catalyst layer was about 0.05 mg/cm². The weight ratio of Pt to CeO₂ is 15 to 1.

A PAH polycation solution with NaCl and PAH was prepared by dissolving NaCl and PAH in deionized (DI) H₂O and adjusting the pH to 2.3 using a HCl aqueous solution. A SPEEK polyanion aqueous solution with NaCl and SPEEK was prepared by dissolving the NaCl and SPEEK in DI H₂O at 80° C. After cooling down to room temperature, the solution was filtered, and the pH was adjusted to 5.8. The H₂R layer comprising Pt and CeO₂ on the coated Nafion® 212 membrane with the other surface of the membrane covered was immersed in the PAH polycation solution for 5 min, and the membrane was rinsed with DI H₂O 3 times. The membrane was then immersed in the SPEEK polyanion solution for 5 min. The membrane was rinsed with DI H₂O 3 times and one PAH/SPEEK polyelectrolyte bilayer was deposited on the surfaces of the H₂R layer comprising Pt and CeO₂ on the coated Nafion® 212 membrane. This process was repeated to deposit 3 sets of PAH/SPEEK polyelectrolyte bilayers on the surfaces of the H₂R layer on the coated Nafion® 212 membrane to form PEL-H₂RCe-PEM membrane.

### Example 4. Preparation of a Membrane Electrode Assembly Comprising PEL-H₂RCe-PEM Membrane (Abbreviated as PEL-H₂RCe-PEM-MEA)

An anode catalyst ink was prepared by mixing IrO₂, an additive solution of poly(3,4-ethylenedioxythiophene) (PEDOT) and poly(styrenesulfonate) (PSS), Nafion® ionomer D2021 solution, H₂O, and ethanol. The mixture was finely dispersed using an ultrasonication bath and ultrasonication probe. The anode catalyst ink was coated onto the surface of the PAH/SPEEK polyelectrolyte bilayers of the PEL-H₂RCe-PEM membrane using a Mayer rod coating method. The anode IrO₂ loading was about 1.0 mg/cm².

A cathode catalyst ink was prepared by mixing 40% Pt/C catalyst, Nafion® ionomer D2021 solution, H₂O, and ethanol. The mixture was finely dispersed using an ultrasonication bath and ultrasonication probe. The cathode catalyst ink was coated onto a second surface of the PEL-H₂RCe-PEM membrane using a Mayer rod coating method to form a three-layer membrane electrode assembly (abbreviated PEL-H₂RCe-PEM-MEA). The cathode Pt loading was about 0.2 mg/cm².

### Example 5. Evaluation of Water Electrolysis Performance of a) PEL-PEM MEA; (b) PEL-H₂R-PEM MEA; and (c) PEL-H₂RCe-PEM MEA, Respectively, at 80° C., Atmospheric Pressure

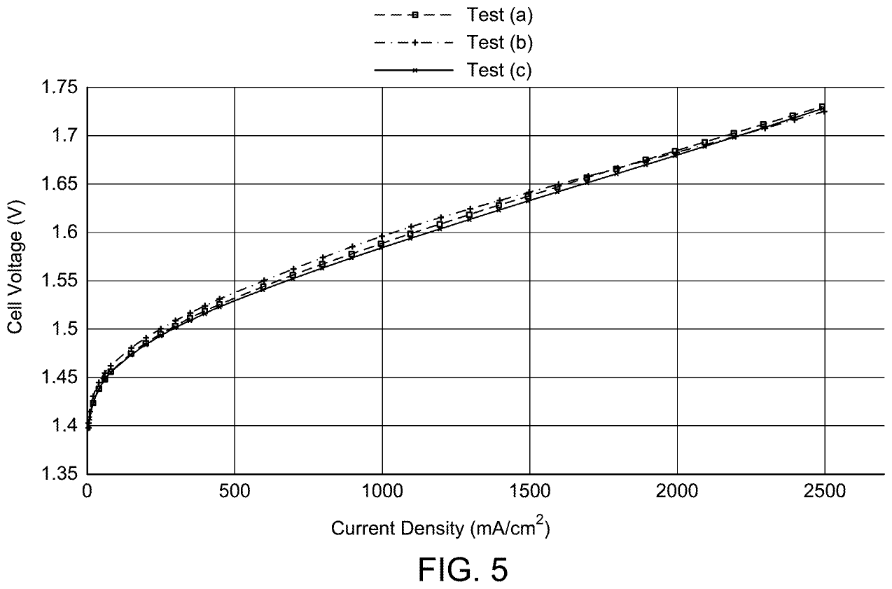

A proton exchange membrane (PEM) water electrolysis test station (Scribner 600 electrolyzer test system) was used to evaluate the water electrolysis performance of a) PEL-PEM-MEA; (b) PEL-H₂R-PEM-MEA; and (c) PEL-H₂RCe-PEM-MEA, respectively, in a single electrolyzer cell with an active membrane area of 5 cm². The test station included an integrated power supply, a potentiostat, an impedance analyzer for electrochemical impedance spectroscopy (EIS) and high-frequency resistance (HFR), and real-time sensors for product flow rate and cross-over monitoring. The MEA was sandwiched between a carbon paper (as a cathode PTL) and a Pt—Ti-felt (as an anode PTL). The testing was conducted at 80° C. and at atmospheric pressure. Ultrapure water was supplied to the anode of the MEA with a flow rate of 100 mL/min. The polarization curve was collected at 80° C. and the results are shown in FIG. 5. The H₂ concentration in O₂ in the anode gas stream was measured by gas chromatography (GC).

It can be observed from the polarization curves in FIG. 5 that both PEL-H₂R-PEM-MEA (b) and PEL-H₂RCe-PEM-MEA (c) with H₂R layer showed performance comparable to PEL-PEM-MEA (a) without H₂R layer. In addition, the PEL-H₂R-PEM-MEA and PEL-H₂RCe-PEM-MEA showed very low H₂ concentration in O₂ of less than 0.1% in the anode gas stream at 2 A/cm² current density. The PEL-PEM-MEA without H₂R layer showed higher H₂ concentration in O₂ of 1.0% at 2 A/cm² current density in the anode gas stream.

### SPECIFIC EMBODIMENTS

While the following is described in conjunction with specific embodiments, it will be understood that this description is intended to illustrate and not limit the scope of the preceding description and the appended claims.

A first embodiment of the invention is a multilayer ion-exchange membrane comprising an ion-exchange membrane layer; a catalyst layer coated on a first surface of the ion-exchange membrane layer; and, a first polyelectrolyte multilayer coating coated on the catalyst layer. An embodiment of the invention is one, any or all of prior embodiments in this paragraph up through the first embodiment in this paragraph, wherein the first polyelectrolyte multilayer coating is thinner than the ion-exchange membrane layer and comprises alternating layers of a polycation polymer and a polyanion polymer. An embodiment of the invention is one, any or all of prior embodiments in this paragraph up through the first embodiment in this paragraph, further comprising a second polyelectrolyte multilayer coating coated on a second surface of the ion-exchange membrane layer. An embodiment of the invention is one, any or all of prior embodiments in this paragraph up through the first embodiment in this paragraph, wherein the first polyelectrolyte multilayer coating and the second polyelectrolyte multilayer coating are thinner than the ion-exchange membrane layer. An embodiment of the invention is one, any or all of prior embodiments in this paragraph up through the first embodiment in this paragraph, wherein both the first polyelectrolyte multilayer coating and the second polyelectrolyte multilayer coating comprise alternating layers of a polycation polymer and a polyanion polymer. An embodiment of the invention is one, any or all of prior embodiments in this paragraph up through the first embodiment in this paragraph, wherein the catalyst layer comprises a catalyst and an ionomer. An embodiment of the invention is one, any or all of prior embodiments in this paragraph up through the first embodiment in this paragraph, wherein the catalyst comprises Pt, PtCo, Pd, PdCo, or mixtures thereof. An embodiment of the invention is one, any or all of prior embodiments in this paragraph up through the first embodiment in this paragraph, wherein the ionomer comprises a proton-conductive fluorinated or non-fluorinated polymeric ionomer, or a hydroxide-conductive polymeric ionomer. An embodiment of the invention is one, any or all of prior embodiments in this paragraph up through the first embodiment in this paragraph, wherein the catalyst layer further comprises an additive. An embodiment of the invention is one, any or all of prior embodiments in this paragraph up through the first embodiment in this paragraph, wherein the additive comprises CeO₂, Ce(OH)₄, CeO₂/ZrO₂, Ce(OH)₄/ZrO₂, or mixtures thereof. An embodiment of the invention is one, any or all of prior embodiments in this paragraph up through the first embodiment in this paragraph, wherein the catalyst layer is thinner than the ion-exchange membrane layer and thicker than the first polyelectrolyte multilayer coating.

A second embodiment of the invention is a membrane electrode assembly comprising an ion-exchange membrane layer; a catalyst layer coated on a first surface on a first side of the ion-exchange membrane layer; a first polyelectrolyte multilayer coating coated on the catalyst layer; an anode electrode disposed on a surface of the first polyelectrolyte multilayer coating; and, a cathode electrode disposed on a second side of the ion-exchange membrane layer. An embodiment of the invention is one, any or all of prior embodiments in this paragraph up through the second embodiment in this paragraph, wherein the first polyelectrolyte multilayer coating is thinner than the ion-exchange membrane layer and comprises alternating layers of a polycation polymer and a polyanion polymer. An embodiment of the invention is one, any or all of prior embodiments in this paragraph up through the second embodiment in this paragraph, further comprising a second polyelectrolyte multilayer coating between the ion-exchange membrane layer and the cathode electrode and, the second polyelectrolyte multilayer coating coated on a second surface on a second side of the ion-exchange membrane layer. An embodiment of the invention is one, any or all of prior embodiments in this paragraph up through the second embodiment in this paragraph, wherein the first polyelectrolyte multilayer coating and the second polyelectrolyte multilayer coating are thinner than the ion-exchange membrane layer. An embodiment of the invention is one, any or all of prior embodiments in this paragraph up through the second embodiment in this paragraph, wherein both the first polyelectrolyte multilayer coating and the second polyelectrolyte multilayer coating comprise alternating layers of a polycation polymer and a polyanion polymer. An embodiment of the invention is one, any or all of prior embodiments in this paragraph up through the second embodiment in this paragraph, wherein the catalyst layer comprises a catalyst and an ionomer. An embodiment of the invention is one, any or all of prior embodiments in this paragraph up through the second embodiment in this paragraph, wherein the catalyst comprises Pt, PtCo, Pd, PdCo, or mixtures thereof. An embodiment of the invention is one, any or all of prior embodiments in this paragraph up through the second embodiment in this paragraph, wherein the ionomer comprises a proton-conductive fluorinated or non-fluorinated polymeric ionomer, or a hydroxide-conductive polymeric ionomer. An embodiment of the invention is one, any or all of prior embodiments in this paragraph up through the second embodiment in this paragraph, wherein the catalyst layer further comprises an additive. An embodiment of the invention is one, any or all of prior embodiments in this paragraph up through the second embodiment in this paragraph, wherein the additive comprises CeO₂, Ce(OH)₄, CeO₂/ZrO₂, Ce(OH)₄/ZrO₂, or mixtures thereof. An embodiment of the invention is one, any or all of prior embodiments in this paragraph up through the second embodiment in this paragraph, wherein the catalyst layer is thinner than the ion-exchange membrane layer and thicker than the first polyelectrolyte multilayer coating.

A third embodiment of the invention is a process for preparing a multilayer ion-exchange membrane, the process comprising coating a catalyst layer on a first surface of a first side of an ion-exchange membrane; and, coating a first polyelectrolyte multilayer on the catalyst layer. An embodiment of the invention is one, any or all of prior embodiments in this paragraph up through the third embodiment in this paragraph further comprising coating a second polyelectrolyte multilayer on a second surface on a second side of the ion-exchange membrane, wherein the coating of the second polyelectrolyte multilayer is done during or after the coating of the first polyelectrolyte multilayer. An embodiment of the invention is one, any or all of prior embodiments in this paragraph up through the third embodiment in this paragraph further comprising applying a cathode electrode on the second surface on a second side of the ion-exchange membrane. An embodiment of the invention is one, any or all of prior embodiments in this paragraph up through the third embodiment in this paragraph further comprising applying an anode electrode on the first polyelectrolyte multilayer.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A multilayer ion-exchange membrane comprising:
an ion-exchange membrane layer;
a catalyst layer coated on a first surface of the ion-exchange membrane layer; and,
a first polyelectrolyte multilayer coating coated on the catalyst layer or a first polyelectrolyte multilayer coating coated on the catalyst layer and a second polyelectrolyte multilayer coating coated on a second surface of the ion-exchange membrane layer.

2. The multilayer ion-exchange membrane of claim 1, wherein the first polyelectrolyte multilayer coating is thinner than the ion-exchange membrane layer and comprises alternating layers of a polycation polymer and a polyanion polymer.

3. The multilayer ion-exchange membrane of claim 1, comprising the first polyelectrolyte multilayer and the second polyelectrolyte multilayer,
wherein both the first polyelectrolyte multilayer coating and the second polyelectrolyte multilayer coating comprise alternating layers of a polycation polymer and a polyanion polymer.

4. The multilayer ion-exchange membrane of claim 1, wherein the catalyst layer comprises a catalyst and an ionomer.

5. The multilayer ion-exchange membrane of claim 4, wherein the catalyst comprises Pt, PtCo, Pd, PdCo, or mixtures thereof.

6. The multilayer ion-exchange membrane of claim 4, wherein the ionomer comprises a proton-conductive fluorinated or non-fluorinated polymeric ionomer, or a hydroxide-conductive polymeric ionomer.

7. The multilayer ion-exchange membrane of claim 1, wherein the catalyst layer further comprises an additive.

8. The multilayer ion-exchange membrane of claim 7, wherein the additive comprises CeO₂, Ce(OH)₄, CeO₂/ZrO₂, Ce(OH)₄/ZrO₂, or mixtures thereof.

9. The multilayer ion-exchange membrane of claim 1, wherein the catalyst layer is thinner than the ion-exchange membrane layer and thicker than the first polyelectrolyte multilayer coating.

10. A membrane electrode assembly comprising:
an ion-exchange membrane layer;
a catalyst layer coated on a first surface on a first side of the ion-exchange membrane layer;
a first polyelectrolyte multilayer coating coated on the catalyst layer;
an anode electrode disposed on a surface of the first polyelectrolyte multilayer coating;
a cathode electrode disposed on a second surface on a second side of the ion-exchange membrane layer or a second polyelectrolyte multilayer coating coated on a second surface on a second side of the ion-exchange membrane layer and a cathode electrode disposed on the second polyelectrolyte multilayer coating.

11. The membrane electrode assembly of claim 10, wherein the first polyelectrolyte multilayer coating is thinner than the ion-exchange membrane layer and comprises alternating layers of a polycation polymer and a polyanion polymer.

12. The membrane electrode assembly of claim 10, comprising the second polyelectrolyte multilayer coating, and,
wherein both the first polyelectrolyte multilayer coating and the second polyelectrolyte multilayer coating comprise alternating layers of a polycation polymer and a polyanion polymer.

13. The membrane electrode assembly of claim 10, wherein the catalyst layer comprises a catalyst and an ionomer.

14. The membrane electrode assembly of claim 13, wherein the catalyst comprises Pt, PtCo, Pd, PdCo, or mixtures thereof.

15. The membrane electrode assembly of claim 13, wherein the ionomer comprises a proton-conductive fluorinated or non-fluorinated polymeric ionomer, or a hydroxide-conductive polymeric ionomer.

16. The membrane electrode assembly of claim 10, wherein the catalyst layer further comprises an additive.

17. The membrane electrode assembly of claim 16, wherein the additive comprises CeO₂, Ce(OH)₄, CeO₂/ZrO₂, Ce(OH)₄/ZrO₂, or mixtures thereof.

18. A process for preparing a multilayer ion-exchange membrane, the process comprising:
coating a catalyst layer on a first surface of a first side of an ion-exchange membrane; and,
coating a first polyelectrolyte multilayer on the catalyst layer.

19. The process of claim 18, further comprising:
coating a second polyelectrolyte multilayer on a second surface on a second side of the ion-exchange membrane, wherein the coating of the second polyelectrolyte multilayer is done during or after the coating of the first polyelectrolyte multilayer.

20. The process of claim 19, further comprising:
applying an anode electrode on the first polyelectrolyte multilayer and applying a cathode electrode on the second surface on a second side of the ion-exchange membrane.
